(19) United States
(12) Patent Application Publication
(10) Pub. No.: US 2023/0150827 A1
(43) Pub. Date: May 18, 2023

(54) ZEOLITE OF A NEW FRAMEWORK STRUCTURE TYPE AND PRODUCTION THEREOF

(71) Applicant: BASF SE, Ludwigshafen am Rhein (DE)

(72) Inventors: Andrei-Nicolae Parvulescu, Ludwigshafen (DE); Ulrich Mueller, Neustadt (DE); Tress Maria De Baerdemaeker, Ludwigshafen (DE); Ute Kolb, Mainz (DE); Bernd Marler, Bochum (DE); Feng-Shou Xiao, Hangzhou (CN); Toshiyuki Yokoi, Tokyo (JP); Weiping Zhang, Dalian (CN); Dirk De Vos, Leuven (BE); Xiangju Meng, Hangzhou (CN)

(21) Appl. No.: 17/917,331

(22) PCT Filed: Mar. 23, 2021
(86) PCT No.: PCT/CN2021/082430

§ 371 Date: Oct. 6, 2022

(30) Foreign Application Priority Data
Apr. 7, 2020 (CN) PCT/CN2020/083520

(51) Int. Cl. C01B 39/12; C01B 39/04

(52) U.S. Cl. CPC C01B 39/12; C01B 39/04; C01P 2002/77; C01P 2002/76; C01P 2002/72

(57) ABSTRACT

The present invention relates to a crystalline material having a framework structure comprising O and one or more tetravalent elements Y, and optionally comprising one or more trivalent elements X, wherein the crystalline material displays a crystallographic unit cell of the monoclinic space group C2, wherein the unit cell parameter a is in the range of from 14.5 to 20.5 Å, the M unit cell parameter b is in the range of from 14.5 to 20.5 Å, the unit cell parameter c in the range of from 11.5 to 17.5 Å and the unit cell parameter β is in the range of from 109 to 118°, wherein the framework density is in the range of from 11 to 23 T-atoms/1000 Å³ wherein the framework structure comprises 12 membered rings, and wherein the framework structure displays a 2-dimensional channel e dimensionality of 12 membered ring channels. The present invention further relates to a process for the production of said material, as N well as to its use, in particular as a catalyst or catalyst component.

The present invention relates to a novel zeolite, in particular to a zeolitic material designated as COE-11 and having a novel framework structure.

### TECHNICAL BACKGROUND

According to the Atlas of Zeolite Framework Types, there are 176 unique zeolite framework types that had been approved and assigned a 3-letter code by the Structure Commission of the IZA (IZA-SC) by February 2007. According to the online database of the International Zeolite Association 248 zeolites having a different framework structure or at least disordered structure exist. This number of verified framework types reflects the vibrant activity that persists within the zeolite community. Zeolites and zeolitic materials do not comprise an easily definable family of crystalline solids. A simple criterion for distinguishing zeolites and zeolite-like materials from denser tectosilicates is based on the framework density (FD), the number of tetrahedrally coordinated framework atoms (T-atoms) per 1000 Å3.

For each framework type code detailed information characterizing the respective zeolite is disclosed in the Atlas of Zeolite Framework Types, including crystallographic data (highest possible space group, cell constants of the idealized framework), coordination sequences, vertex symbols and composite building units. Taken together, the coordination sequences and the vertex symbols define the Framework Type. Further, data for the Type Material, i. e. the real material on which the idealized framework type is based, can be found in the Atlas.

The synthesis of a zeolitic material can generally be performed using one or more source materials for the framework structure and one or more of a structure directing agent and a seed crystal. The reaction mixture is typically a synthesis gel having a specific molar ratio of the one or more source materials to the one or more of a structure directing agent and a seed crystal. Usually, hydrothermal conditions are then applied on the reaction mixture for the crystallizing a zeolitic material. An extensive compilation of syntheses of zeolitic materials is given in the textbook Verified Syntheses of Zeolitic Materials.

Thus, it was an object of the present invention to provide a novel zeolitic material, in particular a zeolitic material having characteristic features, especially a novel framework structure type. Further, it was an object to provide a process for preparation of such a zeolitic material. Surprisingly, it was found that a novel zeolitic material can be provided particularly characterized in that it has a novel and unique framework structure type.

### DETAILED DESCRIPTION

The present invention relates to a crystalline material having a framework structure comprising O and one or more tetravalent elements Y, and optionally comprising one or more trivalent elements X, wherein the crystalline material displays a crystallographic unit cell of the monoclinic space group C2, wherein the unit cell parameter a is in the range of from 14.5 to 20.5 Å, the unit cell parameter b is in the range of from 14.5 to 20.5 Å, the unit cell parameter c in the range of from 11.5 to 17.5 Å, and the unit cell parameter β is in the range of from 109 to 118°, wherein the framework density is in the range of from 11 to 23 T-atoms/1000 Å³, wherein the framework structure comprises 12 membered rings, and wherein the framework structure displays a 2-dimensional channel dimensionality of 12 membered ring channels.

It is preferred that the unit cell parameter a is in the range of from 15.5 to 19.5 Å, more preferably in the range of from 16.5 to 18.5 Å, more preferably in the range of from 17 to 18 Å, more preferably in the range of from 17.3 to 17.5 Å, more preferably in the range of from 17.33 to 17.43 Å.

It is preferred that the unit cell parameter b is in the range of from 15.5 to 19.5 Å, more preferably in the range of from 16.5 to 18.5 Å, more preferably in the range of from 17 to 18 Å, more preferably in the range of from 17.2 to 17.5 Å, more preferably in the range of from 17.31 to 17.41 Å.

It is preferred that the unit cell parameter c is in the range of from 12.5 to 16.5 Å, more preferably in the range of from 13.5 to 15.5 Å, more preferably in the range of from 14 to 15 Å, more preferably in the range of from 14.2 to 14.5 Å, more preferably in the range of from 14.31 to 14.41 Å.

It is preferred that the unit cell parameter β is in the range of from 110 to 117°, more preferably in the range of from 111 to 116°, more preferably in the range of from 112 to 115°, more preferably in the range of from 113.0 to 114.4° more preferably in the range of from 113.5 to 113.9°.

It is preferred that the framework density is in the range of from 13 to 21 T-atoms/1000 Å3, more preferably in the range of from 14 to 20 T-atoms/1000 Å³, more preferably in the range of from 15.6 to 18.1 T-atoms/1000 Å³, more preferably in the range of from 16.6 to 17.1 T-atoms/1000 Å³, more preferably in the range of from 16.6 to 16.8 T-atoms/1000 Å³.

It is preferred that the crystalline material displays an X-ray diffraction pattern comprising at least the following reflections:

| Intensity (%) | Diffraction angle 2θ/° [Cu K(alpha 1)] |
|---|---|
| [68-88] | [6.65-6.85] |
| 100 | [7.43-7.63] |
| [50-70] | [8.39-8.59] |
| [6-26] | [18.21-18.41] |
| [11-31] | [21.35-21.55] |
| [78-99] | [22.64-22.84] |
| [23-43] | [25.55-25.75] |
| [1-17] | [29.80-30.00] |
| [1-20] | [44.12-44.32] |

wherein 100% relates to the intensity of the maximum peak in the X-ray powder diffraction pattern,

wherein the crystalline material more preferably displays an X-ray diffraction pattern comprising at least the following reflections:

| Intensity (%) | Diffraction angle 2θ/° [Cu K(alpha 1)] |
|---|---|
| [73-83] | [6.70-6.80] |
| 100 | [7.48-7.58] |
| [55-65] | [8.44-8.54] |
| [11-21] | [18.26-18.36] |
| [16-26] | [21.40-21.50] |
| [83-99] | [22.69-22.79] |
| [28-38] | [25.60-25.70] |
| [2-12] | [29.85-29.95] |
| [5-15] | [44.17-44.27] |

wherein 100% relates to the intensity of the maximum peak in the X-ray powder diffraction pattern.

It is preferred that the framework structure comprises one or more of composite building units boa, mor, and bik, wherein the framework structure preferably comprises composite building units bea, mor, and bik.

It is preferred that the framework structure further comprises 4-, 5-, and 6-membered rings.

It is preferred that the framework structure comprises a two dimensional pore system.

It is preferred that the framework structure comprises an elliptical pore, more preferably an elliptical pare having a first pore diameter in the range of from 7.0 to 9.5 Å, more preferably in the range of from 7.8 to 8.4 Å, more preferably in the range of from 8.0 to 8.2 Å, and a second pore diameter in the range of from 4.0 to 6.5 Å, preferably in the range of from 5.0 to 5.6 Å, more preferably in the range of from 5.2 to 5.4 Å.

It is preferred that the T-atoms in the framework structure of the crystalline material are located at the following sites of the unit cell:

| T-atom | Site | | | |
|---|---|---|---|---|
| name | Multiplicity | x | y | z |
| T₁ | 2 | 1 | 0.8801 | 0.5 |
| T₂ | 4 | 0.6904 | 0.1943 | 0.4939 |
| T₃ | 2 | 0.5 | 0.9983 | 0.5 |
| T₄ | 4 | 0.8179 | 0.0629 | 0.5032 |
| T₅ | 4 | 0.5199 | 0.1144 | 0.3516 |
| T₆ | 4 | 0.6287 | 0.8721 | 0.5053 |
| T₇ | 4 | 0.7942 | 0.8164 | 0.6628 |
| T₈ | 4 | 0.6071 | 0.0523 | 0.216 |
| T₉ | 2 | 1 | 0.2405 | 0.5 |
| T₁₀ | 4 | 0.7071 | 0.9256 | 0.3638 |
| T₁₁ | 4 | 0.8306 | 0.8013 | 0.356 |
| T₁₂ | 4 | 0.7361 | 0.181 | 0.2119 |
| T₁₃ | 4 | 0.9012 | 0.1203 | 0.3477 |
| T₁₄ | 4 | 1.0987 | 0.7417 | 0.7765 |
| T₁₅ | 4 | 0.9714 | 0.87 | 0.7841 |
| T₁₆ | 4 | 0.976 | 0.9994 | 0.6561 |
| T₁₇ | 4 | 0.6278 | 0.2027 | −0.0074 |
| T₁₈ | 2 | 0.5 | 0.0771 | 0 |
| T₁₉ | 2 | 0.5 | 0.3323 | 0 |

wherein x, y, and z refer to the axes of the unit cell.

It is preferred that the coordination sequences and the vertex symbols of the T-atoms in the framework structure of the crystalline material are as follows:

| T-atom | | | | | | | | | | | | | |
|---|---|---|---|---|---|---|---|---|---|---|---|---|---|
| name | N₁ | N₂ | N₃ | N₄ | N₅ | N₆ | N₇ | N₈ | N₉ | N₁₀ | N₁₁ | N₁₂ | Vertex Symbol |
| T₁ | 1 | 4 | 12 | 19 | 35 | 45 | 75 | 116 | 146 | 166 | 200 | 249 | 5.5.5.5.5₂.6₂ |
| T₂ | 1 | 4 | 12 | 21 | 32 | 50 | 79 | 107 | 142 | 173 | 212 | 255 | 5.5.5.6₂.5₂.12 |
| T₃ | 1 | 4 | 11 | 24 | 37 | 49 | 71 | 110 | 154 | 178 | 199 | 258 | 4.6₂.5.5.12₂.12₂ |
| T₄ | 1 | 4 | 12 | 20 | 33 | 50 | 73 | 108 | 143 | 175 | 210 | 249 | 5.5.5.5₂.5.12 |
| T₅ | 1 | 4 | 12 | 19 | 34 | 52 | 76 | 109 | 141 | 171 | 212 | 258 | 5.5.5.6.5₂.6 |
| T₆ | 1 | 4 | 11 | 23 | 35 | 52 | 72 | 106 | 147 | 180 | 211 | 249 | 4.5.5.5.12.12₂ |
| T₇ | 1 | 4 | 12 | 18 | 33 | 53 | 79 | 109 | 134 | 171 | 217 | 259 | 5.5.5.5.5₂.6 |
| T₈ | 1 | 4 | 11 | 19 | 32 | 55 | 78 | 106 | 131 | 175 | 217 | 268 | 4.5₂.5.5.5.12₃ |
| T₉ | 1 | 4 | 11 | 21 | 36 | 52 | 74 | 102 | 140 | 182 | 221 | 247 | 4.5₂.5.5.12.12 |
| T₁₀ | 1 | 4 | 12 | 21 | 35 | 51 | 75 | 107 | 146 | 175 | 211 | 255 | 5.5.5.5₂.6.12₂ |
| T₁₁ | 1 | 4 | 12 | 24 | 32 | 50 | 77 | 112 | 147 | 175 | 204 | 263 | 5.5.5.6.6₂.12₂ |
| T₁₂ | 1 | 4 | 11 | 19 | 32 | 55 | 80 | 103 | 135 | 170 | 225 | 263 | 4.5₂.5.5.5.12₃ |
| T₁₃ | 1 | 4 | 12 | 20 | 33 | 52 | 76 | 107 | 140 | 173 | 215 | 256 | 5.5.5.5₂.5.12₂ |
| T₁₄ | 1 | 4 | 11 | 21 | 34 | 53 | 79 | 109 | 137 | 171 | 221 | 262 | 4.6₂.5.5.5.12₃ |
| T₁₅ | 1 | 4 | 11 | 21 | 34 | 53 | 81 | 107 | 139 | 173 | 213 | 270 | 4.6₂.5.5.5.12₃ |
| T₁₆ | 1 | 4 | 12 | 22 | 32 | 52 | 74 | 113 | 147 | 168 | 205 | 261 | 5.5.5.6.5₂.12₂ |
| T₁₇ | 1 | 4 | 9 | 18 | 32 | 54 | 80 | 103 | 127 | 171 | 219 | 275 | 4.4.4.12₄.5.5 |
| T₁₈ | 1 | 4 | 9 | 18 | 32 | 54 | 82 | 100 | 127 | 170 | 228 | 266 | 4.4.4.12₄.5.5 |
| T₁₉ | 1 | 4 | 9 | 18 | 32 | 54 | 78 | 106 | 127 | 170 | 222 | 258 | 4.4.4.12₄.5.5 |

wherein the Vertex Symbol refers to the size and number of the shortest ring on each angle of the T-atom, according to M. O'Keeffe and S. T. Hyde, Zeolites 19, 370 (1997).

It is preferred that the Y:X molar ratio of the framework structure is in the range of from 1 to 100, more preferably in the range of from 5 to 30, more preferably in the range of from 10 to 21, more preferably in the range of from 13 to 18, more preferably in the range of from 14.5 to 16.5, more preferably in the range of from 15.2 to 15.8, more preferably in the range of from 15.4 to 15.6.

It is preferred that the one or more tetravalent elements Y are selected from the group consisting of Si, Sn, Ti, Zr, Ge, and mixtures of two or more thereof, Y more preferably being Si.

It is preferred that the optional one or more trivalent elements X are selected from the group consisting of Al, B, In, Ga, and mixtures of two or more thereof, X more preferably being AI and/or B, wherein more preferably X is B.

It is preferred that the crystalline material contains one or more metals as non-framework elements, more preferably at the ion-exchange sites of the crystalline material, wherein the one or more metals are selected from the group consisting of one or more alkali metals, one or more alkaline earth metals, and one or more transition metals, including mixtures of two or more thereof, wherein preferably the crystalline material contains one or more transition metals as non-framework elements, including mixtures of two or more thereof.

It is preferred that the one or more transition metals are selected from the group consisting of Zr, Cr, Mo, Fe, Co, Ni, Cu, Zn, Ru, Rh, Pd, Ag, Os, Ir, Pt, Au, and mixtures of two or more thereof.

It is preferred that the one or more alkali metals are selected from the group consisting of Li, Na, K, Rb, Cs, and mixtures of two or more thereof, wherein more preferably the one or more alkali metals comprise Na and/or K.

It is preferred that the one or more alkaline earth metals are selected from the group consisting of Mg, Ba, Sr, and mixtures of two or more thereof, wherein more preferably the one or more alkaline earth metals comprise Mg and/or Sr.

It is preferred that the crystalline material contains H⁺ and/or NH₄⁺ as non-framework elements, more preferably at the ion-exchange sites of the crystalline material.

It is preferred that the crystalline material is a zeolite.

It is preferred that the crystalline material has a BET specific surface area in the range of from 300 to 530 m²/g, more preferably in the range of from 350 to 480 m²/g, more preferably in the range of from 400 to 430 m²/g, wherein the BET specific surface area is preferably determined as described in Reference Example 2.

It is preferred that the crystalline material has a micropore volume in the range of from 0.12 to 0.24 cm³/g, more preferably in the range of from 0.15 to 0.21 cm³/g, more preferably in the range of from 0.17 to 0.19 cm³/g, wherein the micropore volume is preferably determined as described in Reference Example 3.

Further, the present invention relates to a method for the production of a crystalline material, preferably of a crystalline material according to any one of the embodiments disclosed herein, said method comprising

(a) preparing a mixture comprising one or more sources of YO₂, optionally one or more sources of X₂O₃, one or more tetraalkylammonium cation R¹R²R³R⁴N⁺-containing compounds as structure directing agent, and optionally comprising seed crystals, wherein Y stands for a tetravalent element and X stands for a trivalent element;

(b) heating the mixture prepared in (a) for obtaining a crystalline material;

(c) optionally isolating the crystalline material obtained in (b);

(d) optionally washing the crystalline material obtained in (b) or (c);

(e) optionally drying and/or calcining the crystalline material obtained in (b), (c), or (d);

wherein R¹, R², R³, and R⁴ independently from one another stand for alkyl.

It is preferred that R¹, R², R³, and R⁴ independently from one another stand for optionally substituted and/or optionally branched (C₁-C₆)alkyl, more preferably (C₁-C₅)alkyl, more preferably (C₁-C₄)alkyl, more preferably (C₂-C₃)alkyl, and even more preferably for optionally substituted ethyl or propyl, wherein even more preferably R¹, R², R³, and R⁴, stand for optionally substituted ethyl, preferably unsubstituted ethyl.

It is preferred that the one or more tetraalkylammonium cation R¹R²R³R⁴N⁺-containing compounds comprise one or more compounds selected from the group consisting of tetra(C₁-C₆)alkylammonium compounds, more preferably tetra(C₁-C₅)alkylammonium compounds, more preferably tetra(C₁-C₄)alkylammonium compounds, and more preferably tetra(C₂-C₃)alkylammonium compounds, wherein independently from one another the alkyl substituents are optionally substituted and/or optionally branched, and wherein more preferably the one or more tetraalkylammonium cation R¹R²R³R⁴N⁺-containing compounds are selected from the group consisting of optionally substituted and/or optionally branched tetrapropylammonium compounds, ethyltripropylammonium compounds, diethyldipropylammonium compounds, triethylpropylammonium compounds, methyltripropylammonium compounds, dimethyldipropylammonium compounds, trimethylpropylammonium compounds, tetraethylammonium compounds, triethylmethylammonium compounds, diethyldimethylammonium compounds, ethyltrimethylammonium compounds, tetramethylammonium compounds, and mixtures of two or more thereof, preferably from the group consisting of optionally substituted and/or optionally branched tetrapropylammonium compounds, ethyltripropylammonium compounds, diethyldipropylammonium compounds, triethylpropylammonium compounds, tetraethylammonium compounds, and mixtures of two or more thereof, preferably from the group consisting of optionally substituted tetraethylammonium compounds, wherein more preferably the one or more tetraalkylammonium cation R¹R²R³R⁴N⁺-containing compounds comprises one or more tetraethylammonium compounds, and wherein more preferably the one or more tetraalkylammonium cation R¹R²R³R⁴N⁺-containing compounds consists of one or more tetraethylammonium compounds.

It is preferred that the one or more tetraalkylammonium cation R¹R²R³R⁴N⁺-containing compounds are salts, more preferably one or more salts selected from the group consisting of halides, preferably chloride and/or bromide, more preferably chloride, hydroxide, sulfate, nitrate, phosphate, acetate, and mixtures of two or more thereof, more preferably from the group consisting of chloride, hydroxide, sulfate, and mixtures of two or more thereof, wherein more preferably the one or more tetraalkylammonium cation R¹R²R³R⁴N⁺-containing compounds are tetraalkylammonium hydroxides and/or chlorides, and even more preferably tetraalkylammonium hydroxides.

It is preferred that a molar ratio R¹R²R³R⁴N⁺:YO₂ of the one or more tetraalkylammonium cations to the one or more sources of YO₂ calculated as YO₂ in the mixture provided according to (a) is comprised in the range of from 0.001 to 10, more preferably in the range of from 0.01 to 5, more preferably in the range of from 0.1 to 1, more preferably in the range of from 0.25 to 0.5, more preferably in the range of from 0.3 to 0.36, more preferably in the range of from 0.32 to 0.34.

It is preferred that the tetravalent element Y is selected from the group consisting of Si, Sn, Ti, Zr, Ge, and mixtures of two or more thereof, Y more preferably being Si.

It is preferred that the trivalent element X is selected from the group consisting of Al, B, In, Ga, and mixtures of two or more thereof, X preferably being AJ and/or B, wherein more preferably X is B.

It is preferred that a YO₂:X₂O₃ molar ratio of the one or more sources of YO₂ calculated as YO₂ to the one or more sources of X₂O₃ calculated as X₂O₃ in the mixture prepared in (a) is in the range of from 1 to 50, more preferably in the range of from 6 to 40, more preferably in the range of from 11 to 30, more preferably in the range of from 16 to 25, more preferably in the range of from 18 to 22, more preferably in the range of from 19 to 21.

It is preferred that the tetravalent element Y is Si, and that the at least one source of YO₂ comprises one or more compounds selected from the group consisting of fumed silica, silica hydrosols, reactive amorphous solid silicas, silica gel, silicic acid, water glass, sodium metasilicate hydrate, sesquisilicate, disilicate, colloidal silica, silicic acid esters, and mixtures of two or more thereof, more preferably from the group consisting of fumed silica, silica hydrosols, reactive amorphous solid silicas, silica gel, silicic acid, colloidal silica, silicic acid esters, and mixtures of two or more thereof, more preferably from the group consisting of fumed silica, silica hydrosols, reactive amorphous solid silicas, silica gel, colloidal silica, and mixtures of two or more thereof, wherein even more preferably the one or more sources for YO₂ comprises fumed silica and/or colloidal silica, preferably colloidal silica.

According to a first alternative, it is preferred that the trivalent element X is B, and the at least one source of X₂O₃ comprises one or more compounds selected from the group consisting of free boric acid, borates, boric esters, and mixtures of two or more thereof, wherein more preferably the at least one source of X₂O₃ comprises boric acid.

According to a second alternative, it is preferred that the trivalent element X is Al, and the one or more sources for X₂O₃ comprises one or more compounds selected from the group consisting of alumina, aluminates, aluminum salts, and mixtures of two or more thereof, more preferably from the group consisting of alumina, aluminum salts, and mixtures of two or more thereof, more preferably from the group consisting of alumina, aluminum tri(C₂-C₃)alkoxide, AlO(OH), Al(OH)₃, aluminum halides, preferably aluminum fluoride and/or chloride and/or bromide, more preferably aluminum fluoride and/or chloride, and even more preferably aluminum chloride, aluminum sulfate, aluminum phosphate, aluminum fluorosilicate, and mixtures of two or more thereof, more preferably from the group consisting of aluminum tri(C₂-C₄)alkoxide, AlO(OH), Al(OH)₃, aluminum chloride, aluminum sulfate, aluminum phosphate, and mixtures of two or more thereof, more preferably from the group consisting of aluminum tri(C₂-C₃)alkoxide, AlO(OH), Al(OH)₃, aluminum chloride, aluminum sulfate, and mixtures of two or more thereof, more preferably from the group consisting of aluminum tripropoxides, AlO(OH), aluminum sulfate, and mixtures of two or more thereof.

It is preferred that the seed crystals comprise one or more crystalline materials according to any one of the embodiments disclosed herein.

It is preferred that the mixture prepared in (a) further comprises a solvent system containing one or more solvents, wherein the solvent system more preferably comprises one or more solvents selected from the group consisting of polar protic solvents and mixtures thereof, preferably from the group consisting of n-butanol, isopropanol, propanol, ethanol, methanol, water, and mixtures thereof,

more preferably from the group consisting of ethanol, methanol, water, and mixtures thereof, wherein more preferably the solvent system comprises water, and wherein more preferably water is used as the solvent system, preferably deionized water.

It is preferred that the mixture prepared in (a) comprises water as the solvent system, wherein a H₂O:YO₂ molar ratio of H₂O to the one or more sources of YO₂ calculated as YO₂ in the mixture prepared in (a) is in the range of from 0.1 to 100, more preferably in the range of from 1 to 50, more preferably in the range of from 5 to 30, more preferably in the range of from 10 to 22, more preferably in the range of from 13 to 19, more preferably in the range of from 15 to 17.

It is preferred that the mixture prepared in (a) further comprises at least one source for OH⁻, wherein said at least one source for OH⁻ more preferably comprises a metal hydroxide, more preferably a hydroxide of an alkali metal, even more preferably sodium and/or potassium hydroxide.

It is preferred that a OH⁻:YO₂ molar ratio of hydroxide to the one or more sources of YO₂ calculated as YO₂ in mixture prepared in (a) is in the range of from 0.01 to 10, more preferably in the range of from 0.05 to 2, more preferably in the range of from 0.1 to 0.9, more preferably in the range of from 0.3 to 0.7, more preferably in the range of from 0.4 to 0.65, more preferably in the range of from 0.45 to 0.60.

It is preferred that in (b) the mixture prepared in (a) is heated to a temperature comprised in the range of from 130 to 190° C., more preferably in the range of from 140 to 180° C., more preferably in the range of from 145 to 175° C., more preferably in the range of from 150 to 170° C., more preferably in the range of from 155 to 165° C.

It is preferred that the heating in (b) is conducted under autogenous pressure, more preferably under solvothermal conditions, and more preferably under hydrothermal conditions.

It is preferred that the heating in (b) is conducted for a period comprised in the range of from 1 to 15 d, more preferably in the range of from 3 to 11 d, more preferably in the range of from 5 to 9 d, more preferably in the range of from 6 to 8 d.

According to an alternative embodiment, heating in (b) comprises heating the mixture prepared in (a) at a first temperature T₁ for a first duration and subsequently increasing the first temperature T₁ to a second temperature T₂ for a second duration, wherein T₁<T₂, and wherein the total duration of heating is comprised in the range of from 1 to 15 d, more preferably in the range of from 3 to 11 d, more preferably in the range of from 5 to 9 d, more preferably in the range of from 6 to 8 d.

In the case where heating in (b) comprises heating the mixture prepared in (a) at a first temperature T₁ for a first duration and subsequently increasing the first temperature T₁ to a second temperature T₂ for a second duration, it is preferred that the first temperature T₁ is in the range of from 130 to 180° C., more preferably in the range of from 140 to 170° C., more preferably in the range of from 145 to 165° C., more preferably in the range of from 150 to 160° C.

Further in the case where heating in (b) comprises heating the mixture prepared in (a) at a first temperature T₁ for a first duration and subsequently increasing the first temperature T₁ to a second temperature T₂ for a second duration, it is preferred that the first duration is comprised in the range of from 1 h to 8 d, more preferably in the range of from 6 h to 6 d, more preferably in the range of from 12 h to 5 d, more preferably in the range of from 1 to 4 d.

Further in the case where heating in (b) comprises heating the mixture prepared in (a) at a first temperature T₁ for a first duration and subsequently increasing the first temperature T₁ to a second temperature T₂ for a second duration, it is preferred that the second temperature T₂ is in the range of from 140 to 190° C., more preferably in the range of from 150 to 180° C., more preferably in the range of from 155 to 175° C., more preferably in the range of from 160 to 170° C.

Further in the case where heating in (b) comprises heating the mixture prepared in (a) at a first temperature T₁ for a first duration and subsequently increasing the first temperature T₁ to a second temperature T₂ for a second duration, it is preferred that the second duration is comprised in the range of from 12 h to 10 d, more preferably in the range of from 1 d to 8 d, more preferably in the range of from 2 d to 7 d, more preferably in the range of from 3 to 6 d.

It is preferred that the crystallization in (b2) involves agitating the mixture, more preferably by stirring.

It is preferred that in (c) isolating the crystalline material obtained in (b) is performed via filtration or centrifugation.

It is preferred that in (d) washing the crystalline material obtained in (b) or (c) is performed using a solvent system containing one or more solvents, wherein the solvent system preferably comprises one or more solvents selected from the group consisting of polar protic solvents and mixtures thereof,

preferably from the group consisting of n-butanol, isopropanol, propanol, ethanol, methanol, water, and mixtures thereof,

more preferably from the group consisting of ethanol, methanol, water, and mixtures thereof, wherein more preferably the solvent system comprises water, and wherein more preferably water is used as the solvent system, preferably deionized water.

It is preferred that in (e) drying the crystalline material obtained in (b), (c), or (d) is performed in a gas atmosphere having a temperature in the range of from 5 to 200° C., more preferably in the range of from 15 to 100° C., more preferably in the range of from 20 to 25° C.

It is preferred that in (e) calcining the crystalline material obtained in (b), (c), or (d) is performed in a gas atmosphere having a temperature in the range of from 450 to 750° C., more preferably in the range of from 500 to 700° C., more preferably in the range of from 575 to 625° C., more preferably in the range of from 590 to 610° C.

In the case where the method further comprises drying and/or calcining in (e), it is preferred that the gas atmosphere comprises one or more of nitrogen and oxygen, wherein the gas atmosphere preferably comprises air.

The method may comprise further process steps. It is preferred that the method further comprises

(f) subjecting the crystalline material obtained in (b), (c), (d), or (e) to an ion-exchange procedure, wherein one or more cationic non-framework elements or compounds contained in the crystalline material is ion-exchanged against one or more metal cations.

In the case where the method further comprises (f), it is preferred that the one or more metal cations are selected from the group consisting of one or more alkali metal cations, one or more alkaline earth metal cations, and one or more transition metal cations, including mixtures of two or more thereof, wherein more preferably the one or more metal cations comprise one or more transition metal cations as non-framework elements, including mixtures of two or more thereof.

Further in the case where the method further comprises (f), it is preferred that the one or more transition metal cations are selected from the group consisting of cations of Zr, Cr, Mo, Fe, Co, Ni, Cu, Zn, Ru, Rh, Pd, Ag, Os, Ir, Pt, Au, and mixtures of two or more thereof.

Further in the case where the method further comprises (f), it is preferred that the one or more alkali metal cations are selected from the group consisting of cations of Li, Na, K, Rb, Cs, and mixtures of two or more thereof, wherein more preferably the one or more alkali metal cations comprise cations of Na and/or K.

Further in the case where the method further comprises (f), it is preferred that the one or more alkaline earth metal cations are selected from the group consisting of cations of Mg, Ba, Sr, and mixtures of two or more thereof, wherein more preferably the one or more alkaline earth metal cations comprise cations of Mg and/or Sr.

As outlined above, the method may comprise further process steps. It is preferred that the method further comprises

(g) subjecting the crystalline material obtained in (b), (c), (d), (e), or (f) to an ion-exchange procedure, wherein one or more cationic non-framework elements or compounds contained in the crystalline material is ion-exchanged against ammonium cations.

Yet further, the present invention relates to a crystalline material obtainable or obtained according to the process of any one of the embodiments disclosed herein.

Yet further, the present invention relates to a use of a crystalline material according to any one of the embodiments disclosed herein as a molecular sieve, for ion-exchange, as an adsorbent, as an absorbent, as a catalyst or as a catalyst component, more preferably as a catalyst or as a catalyst component, more preferably as a Lewis acid catalyst or a Lewis acid catalyst component, as a catalyst for the selective catalytic reduction (SCR) of nitrogen oxides NOₓ, for the oxidation of NH₃, in particular for the oxidation of NH₃ slip in diesel systems, for the decomposition of N₂O, as an additive in fluid catalytic cracking (FCC) processes, as an isomerization catalyst or as an isomerization catalyst component, as an oxidation catalyst or as an oxidation catalyst component, as a hydrocracking catalyst, as an alkylation catalyst, as an aldol condensation catalyst or as an aldol condensation catalyst component, as an amination catalyst, in particular for the amination of one or more of an alcohol, an epoxide, an olefin, and an aromatic, as an acylation catalyst, as an esterification catalyst, as a transesterification catalyst, or as a Prins reaction catalyst or as a Prins reaction catalyst component, more preferably as an oxidation catalyst or as an oxidation catalyst component, more preferably as an epoxidation catalyst or as an epoxidation catalyst component, more preferably as an epoxidation catalyst, or as a catalyst in the conversion of alcohols to olefins, and more preferably in the conversion of oxygenates to olefins.

The unit bar(abs) refers to an absolute pressure of 105 Pa and the unit Angstrom refers to a length of 10⁻¹⁰ m.

The present invention is further illustrated by the following set of embodiments and combinations of embodiments resulting from the dependencies and back-references as indicated. In particular, it is noted that in each instance where a range of embodiments is mentioned, for example in the context of a term such as “any one of embodiments (1) to (4)”, every embodiment in this range is meant to be explicitly disclosed for the skilled person, i.e. the wording of this term is to be understood by the skilled person as being synonymous to “any one of embodiments (1), (2), (3), and (4).

Further, it is explicitly noted that the following set of embodiments is not the set of claims determining the extent of protection, but represents a suitably structured part of the description directed to general and preferred aspects of the present invention.

According to an embodiment (1), the present invention relates to a crystalline material having a framework structure comprising O and one or more tetravalent elements Y, and optionally comprising one or more trivalent elements X, wherein the crystalline material displays a crystallographic unit cell of the monoclinic space group C2, wherein the unit cell parameter a is in the range of from 14.5 to 20.5 Å, the unit cell parameter b is in the range of from 14.5 to 20.5 Å, the unit cell parameter c in the range of from 11.5 to 17.5 Å, and the unit cell parameter β is in the range of from 109 to 118°, wherein the framework density is in the range of from 11 to 23 T-atoms/1000 Å³, wherein the framework structure comprises 12 membered rings, and wherein the framework structure displays a 2-dimensional channel dimensionality of 12 membered ring channels.

A preferred embodiment (2) concretizing embodiment (1) relates to said crystalline material, wherein the unit cell parameter a is in the range of from 15.5 to 19.5 Å, preferably in the range of from 16.5 to 18.5 Å, more preferably in the range of from 17 to 18 Å, more preferably in the range of from 17.3 to 17.5 Å, more preferably in the range of from 17.33 to 17.43 Å.

A further preferred embodiment (3) concretizing embodiment (1) or (2) relates to said crystalline material, wherein the unit cell parameter b is in the range of from 15.5 to 19.5 Å, preferably in the range of from 16.5 to 18.5 Å, more preferably in the range of from 17 to 18 Å, more preferably in the range of from 17.2 to 17.5 Å, more preferably in the range of from 17.31 to 17.41 Å.

A further preferred embodiment (4) concretizing any one of embodiments (1) to (3) relates to said crystalline material, wherein the unit cell parameter cis in the range of from 12.5 to 16.5 Å, preferably in the range of from 13.5 to 15.5 Å, more preferably in the range of from 14 to 15 Å, more preferably in the range of from 14.2 to 14.5 Å, more preferably in the range of from 14.31 to 14.41 Å.

A further preferred embodiment (5) concretizing any one of embodiments (1) to (4) relates to said crystalline material, wherein the unit cell parameter β is in the range of from 110 to 117°, preferably in the range of from 111 to 116°, more preferably in the range of from 112 to 115°, more preferably in the range of from 113.0 to 114.4° more preferably in the range of from 113.5 to 113.9°.

A further preferred embodiment (6) concretizing any one of embodiments (1) to (5) relates to said crystalline material, wherein the framework density is in the range of from 13 to 21 T-atoms/1000 Å³, preferably in the range of from 14 to 20 T-atoms/1000 Å³, more preferably in the range of from 15.6 to 18.1 T-atoms/1000 Å³, more preferably in the range of from 16.6 to 17.1 T-atoms/1000 Å³, more preferably in the range of from 16.6 to 16.8 T-atoms/1000 Å³.

A further preferred embodiment (7) concretizing any one of embodiments (1) to (6) relates to said crystalline material, wherein the crystalline material displays an X-ray diffraction pattern comprising at least the following reflections:

| Intensity (%) | Diffraction angle 2θ/° [Cu K(alpha 1)] |
|---|---|
| [68-88] | [6.65-6.85] |
| 100 | [7.43-7.63] |
| [50-70] | [8.39-8.59] |
| [6-26] | [18.21-18.41] |
| [11-31] | [21.35-21.55] |
| [78-99] | [22.64-22.84] |
| [23-43] | [25.55-25.75] |
| [1-17] | [29.80-30.00] |
| [1-20] | [44.12-44.32] |

wherein 100% relates to the intensity of the maximum peak in the X-ray powder diffraction pattern,

wherein the crystalline material preferably displays an X-ray diffraction pattern comprising at least the following reflections:

| Intensity (%) | Diffraction angle 2θ/° [Cu K(alpha 1)] |
|---|---|
| [73-83] | [6.70-6.80] |
| 100 | [7.48-7.58] |
| [55-65] | [8.44-8.54] |
| [11-21] | [18.26-18.36] |
| [16-26] | [21.40-21.50] |
| [83-99] | [22.69-22.79] |
| [28-38] | [25.60-25.70] |
| [2-12] | [29.85-29.95] |
| [5-15] | [44.17-44.27] |

wherein 100% relates to the intensity of the maximum peak in the X-ray powder diffraction pattern.

A further preferred embodiment (8) concretizing any one of embodiments (1) to (7) relates to said crystalline material, wherein the framework structure comprises one or more of composite building units boa, mor, and bik, wherein the framework structure preferably comprises composite building units boa, mor, and bik.

A further preferred embodiment (9) concretizing any one of embodiments (1) to (8) relates to said crystalline material, wherein the framework structure further comprises 4-, 5-, and 6-membered rings.

A further preferred embodiment (10) concretizing any one of embodiments (1) to (9) relates to said crystalline material, wherein the framework structure comprises a two dimensional pore system.

A further preferred embodiment (11) concretizing any one of embodiments (1) to (10) relates to said crystalline material, wherein the framework structure comprises an elliptical pore, preferably an elliptical pore having a first pore diameter in the range of from 7.0 to 9.5 Å, more preferably in the range of from 7.8 to 8.4 Å, more preferably in the range of from 8.0 to 8.2 Å, and a second pore diameter in the range of from 4.0 to 6.5 Å, preferably in the range of from 5.0 to 5.6 Å, more preferably in the range of from 5.2 to 5.4 Å.

A further preferred embodiment (12) concretizing any one of embodiments (1) to (11) relates to said crystalline material, wherein the T-atoms in the framework structure of the crystalline material are located at the following sites of the unit cell:

| T-atom | Site | | | |
|---|---|---|---|---|
| name | Multiplicity | x | y | z |
| T₁ | 2 | 1 | 0.8801 | 0.5 |
| T₂ | 4 | 0.6904 | 0.1943 | 0.4939 |
| T₃ | 2 | 0.5 | 0.9983 | 0.5 |
| T₄ | 4 | 0.8179 | 0.0629 | 0.5032 |
| T₅ | 4 | 0.5199 | 0.1144 | 0.3516 |
| T₆ | 4 | 0.6287 | 0.8721 | 0.5053 |
| T₇ | 4 | 0.7942 | 0.8164 | 0.6628 |
| T₈ | 4 | 0.6071 | 0.0523 | 0.216 |
| T₉ | 2 | 1 | 0.2405 | 0.5 |
| T₁₀ | 4 | 0.7071 | 0.9256 | 0.3638 |
| T₁₁ | 4 | 0.8306 | 0.8013 | 0.356 |
| T₁₂ | 4 | 0.7361 | 0.181 | 0.2119 |
| T₁₃ | 4 | 0.9012 | 0.1203 | 0.3477 |
| T₁₄ | 4 | 1.0987 | 0.7417 | 0.7765 |
| T₁₅ | 4 | 0.9714 | 0.87 | 0.7841 |
| T₁₆ | 4 | 0.976 | 0.9994 | 0.6561 |
| T₁₇ | 4 | 0.6278 | 0.2027 | −0.0074 |
| T₁₈ | 2 | 0.5 | 0.0771 | 0 |
| T₁₉ | 2 | 0.5 | 0.3323 | 0 |

wherein x, y, and z refer to the axes of the unit cell.

A further preferred embodiment (13) concretizing any one of embodiments (1) to (12) relates to said crystalline material, wherein the coordination sequences and the vertex symbols of the T-atoms in the framework structure of the crystalline material are as follows:

| T-atom | | | | | | | | | | | | | |
|---|---|---|---|---|---|---|---|---|---|---|---|---|---|
| name | N₁ | N₂ | N₃ | N₄ | N₅ | N₆ | N₇ | N₈ | N₉ | N₁₀ | N₁₁ | N₁₂ | Vertex Symbol |
| T₁ | 1 | 4 | 12 | 19 | 35 | 45 | 75 | 116 | 146 | 166 | 200 | 249 | 5.5.5.5.5₂.6₂ |
| T₂ | 1 | 4 | 12 | 21 | 32 | 50 | 79 | 107 | 142 | 173 | 212 | 255 | 5.5.5.6₂.5₂.12 |
| T₃ | 1 | 4 | 11 | 24 | 37 | 49 | 71 | 110 | 154 | 178 | 199 | 258 | 4.6₂.5.5.12₂.12₂ |
| T₄ | 1 | 4 | 12 | 20 | 33 | 50 | 73 | 108 | 143 | 175 | 210 | 249 | 5.5.5.5₂.5.12 |
| T₅ | 1 | 4 | 12 | 19 | 34 | 52 | 76 | 109 | 141 | 171 | 212 | 258 | 5.5.5.6.5₂.6 |
| T₆ | 1 | 4 | 11 | 23 | 35 | 52 | 72 | 106 | 147 | 180 | 211 | 249 | 4.5.5.5.12.12₂ |
| T₇ | 1 | 4 | 12 | 18 | 33 | 53 | 79 | 109 | 134 | 171 | 217 | 259 | 5.5.5.5.5₂.6 |
| T₈ | 1 | 4 | 11 | 19 | 32 | 55 | 78 | 106 | 131 | 175 | 217 | 268 | 4.5₂.5.5.5.12₃ |
| T₉ | 1 | 4 | 11 | 21 | 36 | 52 | 74 | 102 | 140 | 182 | 221 | 247 | 4.5₂.5.5.12.12 |
| T₁₀ | 1 | 4 | 12 | 21 | 35 | 51 | 75 | 107 | 146 | 175 | 211 | 255 | 5.5.5.5₂.6.12₂ |
| T₁₁ | 1 | 4 | 12 | 24 | 32 | 50 | 77 | 112 | 147 | 175 | 204 | 263 | 5.5.5.6.6₂.12₂ |
| T₁₂ | 1 | 4 | 11 | 19 | 32 | 55 | 80 | 103 | 135 | 170 | 225 | 263 | 4.5₂.5.5.5.12₃ |
| T₁₃ | 1 | 4 | 12 | 20 | 33 | 52 | 76 | 107 | 140 | 173 | 215 | 256 | 5.5.5.5₂.5.12₂ |
| T₁₄ | 1 | 4 | 11 | 21 | 34 | 53 | 79 | 109 | 137 | 171 | 221 | 262 | 4.6₂.5.5.5.12₃ |
| T₁₅ | 1 | 4 | 11 | 21 | 34 | 53 | 81 | 107 | 139 | 173 | 213 | 270 | 4.6₂.5.5.5.12₃ |
| T₁₆ | 1 | 4 | 12 | 22 | 32 | 52 | 74 | 113 | 147 | 168 | 205 | 261 | 5.5.5.6.5₂.12₂ |
| T₁₇ | 1 | 4 | 9 | 18 | 32 | 54 | 80 | 103 | 127 | 171 | 219 | 275 | 4.4.4.12₄.5.5 |
| T₁₈ | 1 | 4 | 9 | 18 | 32 | 54 | 82 | 100 | 127 | 170 | 228 | 266 | 4.4.4.12₄.5.5 |
| T₁₉ | 1 | 4 | 9 | 18 | 32 | 54 | 78 | 106 | 127 | 170 | 222 | 258 | 4.4.4.12₄.5.5 |

wherein the Vertex Symbol refers to the size and number of the shortest ring on each angle of the T-atom, according to M. O'Keeffe and S. T. Hyde, Zeolites 19, 370 (1997).

A further preferred embodiment (14) concretizing any one of embodiments (1) to (13) relates to said crystalline material, wherein the Y:X molar ratio of the framework structure is in the range of from 1 to 100, preferably in the range of from 5 to 30, more preferably in the range of from 10 to 21, more preferably in the range of from 13 to 18, more preferably in the range of from 14.5 to 16.5, more preferably in the range of from 15.2 to 15.8, more preferably in the range of from 15.4 to 15.6.

A further preferred embodiment (15) concretizing any one of embodiments (1) to (14) relates to said crystalline material, wherein the one or more tetravalent elements Y are selected from the group consisting of Si, Sn, Ti, Zr, Ge, and mixtures of two or more thereof, Y preferably being Si.

A further preferred embodiment (16) concretizing any one of embodiments (1) to (15) relates to said crystalline material, wherein the optional one or more trivalent elements X are selected from the group consisting of AI, B, In, Ga, and mixtures of two or more thereof, X preferably being Ai and/or B, wherein more preferably X is B.

A further preferred embodiment (17) concretizing any one of embodiments (1) to (16) relates to said crystalline material, wherein the crystalline material contains one or more metals as non-framework elements, preferably at the ion-exchange sites of the crystalline material, wherein the one or more metals are selected from the group consisting of one or more alkali metals, one or more alkaline earth metals, and one or more transition metals, including mixtures of two or more thereof, wherein preferably the crystalline material contains one or more transition metals as non-framework elements, including mixtures of two or more thereof.

A further preferred embodiment (18) concretizing any one of embodiments (1) to (17) relates to said crystalline material, wherein the one or more transition metals are selected from the group consisting of Zr, Cr, Mo, Fe, Co, Ni, Cu, Zn, Ru, Rh, Pd, Ag, Os, Ir, Pt, Au, and mixtures of two or more thereof.

A further preferred embodiment (19) concretizing any one of embodiments (1) to (18) relates to said crystalline material, wherein the one or more alkali metals are selected from the group consisting of Li, Na, K, Rb, Cs, and mixtures of two or more thereof, wherein preferably the one or more alkali metals comprise Na and/or K.

A further preferred embodiment (20) concretizing any one of embodiments (1) to (19) relates to said crystalline material, wherein the one or more alkaline earth metals are selected from the group consisting of Mg, Ba, Sr, and mixtures of two or more thereof, wherein preferably the one or more alkaline earth metals comprise Mg and/or Sr.

A further preferred embodiment (21) concretizing any one of embodiments (1) to (20) relates to said crystalline material, wherein the crystalline material contains H⁺ and/or NH₄⁻ as non-framework elements, preferably at the ion-exchange sites of the crystalline material.

A further preferred embodiment (22) concretizing any one of embodiments (1) to (21) relates to said crystalline material, wherein the crystalline material is a zeolite.

A further preferred embodiment (23) concretizing any one of embodiments (1) to (22) relates to said crystalline material, wherein the crystalline material has a BET specific surface area in the range of from 300 to 530 m²/g, preferably in the range of from 350 to 480 m²/g, more preferably in the range of from 400 to 430 m²/g, preferably determined as described in Reference Example 2.

A further preferred embodiment (24) concretizing any one of embodiments (1) to (23) relates to said crystalline material, wherein the crystalline material has a micropore volume in the range of from 0.12 to 0.24 cm³/g, preferably in the range of from 0.15 to 0.21 cm³/g, more preferably in the range of from 0.17 to 0.19 cm³/g, preferably determined as described in Reference Example 3.

An embodiment (25) of the present invention relates to a method for the production of a crystalline material, preferably of a crystalline material according to any one of embodiments (1) to (24), said method comprising

(a) preparing a mixture comprising one or more sources of YO₂, optionally one or more sources of X₂O₃, one or more tetraalkylammonium cation R¹R²R³R⁴N⁺-containing compounds as structure directing agent, and optionally comprising seed crystals, wherein Y stands for a tetravalent element and X stands for a trivalent element;

(b) heating the mixture prepared in (a) for obtaining a crystalline material;

(c) optionally isolating the crystalline material obtained in (b);

(d) optionally washing the crystalline material obtained in (b) or (c);

(e) optionally drying and/or calcining the crystalline material obtained in (b), (c), or (d);

wherein R¹, R², R³, and R⁴ independently from one another stand for alkyl.

A preferred embodiment (26) concretizing embodiment (25) relates to said method, wherein R¹, R², R³, and R⁴ independently from one another stand for optionally substituted and/or optionally branched (C₁-C₆)alkyl, preferably (C₁-C₅)alkyl, more preferably (C₁-C₄)alkyl, more preferably (C₂-C₃)alkyl, and even more preferably for optionally substituted ethyl or propyl, wherein even more preferably R¹, R², R³, and R⁴, stand for optionally substituted ethyl, preferably unsubstituted ethyl.

A further preferred embodiment (27) concretizing embodiment (25) or (26) relates to said method, wherein the one or more tetraalkylammonium cation R¹R²R³R⁴N⁺-containing compounds comprise one or more compounds selected from the group consisting of tetra(C₁-C₆)alkylammonium compounds, preferably tetra(C₁-C₅)alkylammonium compounds, more preferably tetra(C₁-C₄)alkylammonium compounds, and more preferably tetra(C₂-C₃)alkylammonium compounds, wherein independently from one another the alkyl substituents are optionally substituted and/or optionally branched, and wherein more preferably the one or more tetraalkylammonium cation R¹R²R³R⁴N⁺-containing compounds are selected from the group consisting of optionally substituted and/or optionally branched tetrapropylammonium compounds, ethyltripropylammonium compounds, diethyldipropylammonium compounds, triethylpropylammonium compounds, methyltripropylammonium compounds, dimethyldipropylammonium compounds, trimethylpropylammonium compounds, tetraethylammonium compounds, triethylmethylammonium compounds, diethyldimethylammonium compounds, ethyltrimethylammonium compounds, tetramethylammonium compounds, and mixtures of two or more thereof, preferably from the group consisting of optionally substituted and/or optionally branched tetrapropylammonium compounds, ethyltripropylammonium compounds, diethyldipropylammonium compounds, triethylpropylammonium compounds, tetraethylammonium compounds, and mixtures of two or more thereof, preferably from the group consisting of optionally substituted tetraethylammonium compounds, wherein more preferably the one or more tetraalkylammonium cation R¹R²R³R⁴N⁺-containing compounds comprises one or more tetraethylammonium compounds, and wherein more preferably the one or more tetraalkylammonium cation R¹R²R³R⁴N⁺-containing compounds consists of one or more tetraethylammonium compounds.

A further preferred embodiment (28) concretizing any one of embodiments (25) to (27) relates to said method, wherein the one or more tetraalkylammonium cation R¹R²R³R⁴N⁺-containing compounds are salts, preferably one or more salts selected from the group consisting of halides, preferably chloride and/or bromide, more preferably chloride, hydroxide, sulfate, nitrate, phosphate, acetate, and mixtures of two or more thereof, more preferably from the group consisting of chloride, hydroxide, sulfate, and mixtures of two or more thereof, wherein more preferably the one or more tetraalkylammonium cation R¹R²R³R⁴N⁺-containing compounds are tetraalkylammonium hydroxides and/or chlorides, and even more preferably tetraalkylammonium hydroxides.

A further preferred embodiment (29) concretizing any one of embodiments (25) to (28) relates to said method, wherein a molar ratio R¹R²R³R⁴N⁺:YO₂ of the one or more tetraalkylammonium cations to the one or more sources of YO₂ calculated as YO₂ in the mixture provided according to (a) is comprised in the range of from 0.001 to 10, preferably in the range of from 0.01 to 5, more preferably in the range of from 0.1 to 1, more preferably in the range of from 0.25 to 0.5, more preferably in the range of from 0.3 to 0.36, more preferably in the range of from 0.32 to 0.34.

A further preferred embodiment (30) concretizing any one of embodiments (25) to (29) relates to said method, wherein the tetravalent element Y is selected from the group consisting of Si, Sn, Ti, Zr, Ge, and mixtures of two or more thereof, Y preferably being Si.

A further preferred embodiment (31) concretizing any one of embodiments (25) to (30) relates to said method, wherein the trivalent element X is selected from the group consisting of Al, B, In, Ga, and mixtures of two or more thereof, X preferably being Ai and/or B, wherein more preferably X is B.

A further preferred embodiment (32) concretizing any one of embodiments (25) to (31) relates to said method, wherein a YO₂:X₂O₃ molar ratio of the one or more sources of YO₂ calculated as YO₂ to the one or more sources of X₂O₃ calculated as X₂O₃ in the mixture prepared in (a) is in the range of from 1 to 50, preferably in the range of from 6 to 40, more preferably in the range of from 11 to 30, more preferably in the range of from 16 to 25, more preferably in the range of from 18 to 22, more preferably in the range of from 19 to 21.

A further preferred embodiment (33) concretizing any one of embodiments (25) to (32) relates to said method, wherein the tetravalent element Y is Si, and the at least one source of YO₂ comprises one or more compounds selected from the group consisting of fumed silica, silica hydrosols, reactive amorphous solid silicas, silica gel, silicic acid, water glass, sodium metasilicate hydrate, sesquisilicate, disilicate, colloidal silica, silicic acid esters, and mixtures of two or more thereof, preferably from the group consisting of fumed silica, silica hydrosols, reactive amorphous solid silicas, silica gel, silicic acid, colloidal silica, silicic acid esters, and mixtures of two or more thereof, more preferably from the group consisting of fumed silica, silica hydrosols, reactive amorphous solid silicas, silica gel, colloidal silica, and mixtures of two or more thereof, wherein even more preferably the one or more sources for YO₂ comprises fumed silica and/or colloidal silica, preferably colloidal silica.

A further preferred embodiment (34) concretizing any one of embodiments (25) to (33) relates to said method, wherein the trivalent element X is B, and the at least one source of X₂O₃ comprises one or more compounds selected from the group consisting of free boric acid, borates, boric esters, and mixtures of two or more thereof, wherein preferably the at least one source of X₂O₃ comprises boric acid.

A further preferred embodiment (35) concretizing any one of embodiments (25) to (33) relates to said method, wherein the trivalent element X is Al, and the one or more sources for X₂O₃ comprises one or more compounds selected from the group consisting of alumina, aluminates, aluminum salts, and mixtures of two or more thereof, preferably from the group consisting of alumina, aluminum salts, and mixtures of two or more thereof, more preferably from the group consisting of alumina, aluminum tri(C₁-C₅)alkoxide, AlO(OH), Al(OH)₃, aluminum halides, preferably aluminum fluoride and/or chloride and/or bromide, more preferably aluminum fluoride and/or chloride, and even more preferably aluminum chloride, aluminum sulfate, aluminum phosphate, aluminum fluorosilicate, and mixtures of two or more thereof, more preferably from the group consisting of aluminum tri(C₂-C₄)alkoxide, AlO(OH), Al(OH)₃, aluminum chloride, aluminum sulfate, aluminum phosphate, and mixtures of two or more thereof, more preferably from the group consisting of aluminum tri(C₂-C₃)alkoxide, AlO(OH), Al(OH)₃, aluminum chloride, aluminum sulfate, and mixtures of two or more thereof, more preferably from the group consisting of aluminum tripropoxides, AlO(OH), aluminum sulfate, and mixtures of two or more thereof.

A further preferred embodiment (36) concretizing any one of embodiments (25) to (35) relates to said method, wherein the seed crystals comprise one or more crystalline materials according to any one of embodiments (1) to (24) or (60).

A further preferred embodiment (37) concretizing any one of embodiments (25) to (36) relates to said method, wherein the mixture prepared in (a) further comprises a solvent system containing one or more solvents, wherein the solvent system preferably comprises one or more solvents selected from the group consisting of polar protic solvents and mixtures thereof, preferably from the group consisting of n-butanol, isopropanol, propanol, ethanol, methanol, water, and mixtures thereof,

more preferably from the group consisting of ethanol, methanol, water, and mixtures thereof, wherein more preferably the solvent system comprises water, and wherein more preferably water is used as the solvent system, preferably deionized water.

A further preferred embodiment (38) concretizing any one of embodiments (25) to (37) relates to said method, wherein the mixture prepared in (a) comprises water as the solvent system, wherein a H₂O:YO₂ molar ratio of H₂O to the one or more sources of YO₂ calculated as YO₂ in the mixture prepared in (a) is in the range of from 0.1 to 100, preferably in the range of from 1 to 50, more preferably in the range of from 5 to 30, more preferably in the range of from 10 to 22, more preferably in the range of from 13 to 19, more preferably in the range of from 15 to 17.

A further preferred embodiment (39) concretizing any one of embodiments (25) to (38) relates to said method, wherein the mixture prepared in (a) further comprises at least one source for OH⁻, wherein said at least one source for OH⁻ preferably comprises a metal hydroxide, more preferably a hydroxide of an alkali metal, even more preferably sodium and/or potassium hydroxide.

A further preferred embodiment (40) concretizing any one of embodiments (25) to (39) relates to said method, wherein a OH⁻:YO₂ molar ratio of hydroxide to the one or more sources of YO₂ calculated as YO₂ in mixture prepared in (a) is in the range of from 0.01 to 10, preferably in the range of from 0.05 to 2, more preferably in the range of from 0.1 to 0.9, more preferably in the range of from 0.3 to 0.7, more preferably in the range of from 0.4 to 0.65, more preferably in the range of from 0.45 to 0.60.

A further preferred embodiment (41) concretizing any one of embodiments (25) to (40) relates to said method, wherein in (b) the mixture prepared in (a) is heated to a temperature comprised in the range of from 130 to 190° C., preferably in the range of from 140 to 180° C., more preferably in the range of from 145 to 175° C., more preferably in the range of from 150 to 170° C., more preferably in the range of from 155 to 165° C.

A further preferred embodiment (42) concretizing any one of embodiments (25) to (41) relates to said method, wherein the heating in (b) is conducted under autogenous pressure, preferably under solvothermal conditions, and more preferably under hydrothermal conditions.

A further preferred embodiment (43) concretizing any one of embodiments (25) to (42) relates to said method, wherein the heating in (b) is conducted for a period comprised in the range of from 1 to 15 d, preferably in the range of from 3 to 11 d, more preferably in the range of from 5 to 9 d, more preferably in the range of from 6 to 8 d.

An alternative embodiment (44) concretizing any one of embodiments (25) to (43) relates to said method, wherein heating in (b) comprises heating the mixture prepared in (a) at a first temperature T₁ for a first duration and subsequently increasing the first temperature T₁ to a second temperature T₂ for a second duration, wherein T₁<T₂, and wherein the total duration of heating is comprised in the range of from 1 to 15 d, preferably in the range of from 3 to 11 d, more preferably in the range of from 5 to 9 d, more preferably in the range of from 6 to 8 d.

A further preferred embodiment (45) concretizing embodiment (44) relates to said method, wherein the first temperature T₁ is in the range of from 130 to 180° C., preferably in the range of from 140 to 170° C., more preferably in the range of from 145 to 165° C., more preferably in the range of from 150 to 160° C.

A further preferred embodiment (46) concretizing embodiment (44) or (45) relates to said method, wherein the first duration is comprised in the range of from 1 h to 8 d, preferably in the range of from 6 h to 6 d, more preferably in the range of from 12 h to 5 d, more preferably in the range of from 1 to 4 d.

A further preferred embodiment (47) concretizing any one of embodiments (44) to (46) relates to said method, wherein the second temperature T₂ is in the range of from 140 to 190° C., preferably in the range of from 150 to 180° C., more preferably in the range of from 155 to 175° C., more preferably in the range of from 160 to 170° C.

A further preferred embodiment (48) concretizing any one of embodiments (44) to (47) relates to said method, wherein the second duration is comprised in the range of from 12 h to 10 d, preferably in the range of from 1 d to 8 d, more preferably in the range of from 2 d to 7 d, more preferably in the range of from 3 to 6 d.

A further preferred embodiment (49) concretizing any one of embodiments (25) to (48) relates to said method, wherein the crystallization in (b2) involves agitating the mixture, preferably by stirring.

A further preferred embodiment (50) concretizing any one of embodiments (25) to (49) relates to said method, wherein in (c) isolating the crystalline material obtained in (b) is performed via filtration or centrifugation.

A further preferred embodiment (51) concretizing any one of embodiments (25) to (50) relates to said method, wherein in (d) washing the crystalline material obtained in (b) or (c) is performed using a solvent system containing one or more solvents, wherein the solvent system preferably comprises one or more solvents selected from the group consisting of polar protic solvents and mixtures thereof, preferably from the group consisting of n-butanol, isopropanol, propanol, ethanol, methanol, water, and mixtures thereof,

more preferably from the group consisting of ethanol, methanol, water, and mixtures thereof, wherein more preferably the solvent system comprises water, and wherein more preferably water is used as the solvent system, preferably deionized water.

A further preferred embodiment (52) concretizing any one of embodiments (25) to (51) relates to said method, wherein in (e) drying the crystalline material obtained in (b), (c), or (d) is performed in a gas atmosphere having a temperature in the range of from 5 to 200° C., preferably in the range of from 15 to 100° C., more preferably in the range of from 20 to 25° C.

A further preferred embodiment (51) concretizing any one of embodiments (25) to (52) relates to said method, wherein in (e) calcining the crystalline material obtained in (b), (c), or (d) is performed in a gas atmosphere having a temperature in the range of from 450 to 750° C., preferably in the range of from 500 to 700° C., more preferably in the range of from 575 to 625° C., more preferably in the range of from 590 to 610° C.

A further preferred embodiment (54) concretizing embodiment (52) to (53) relates to said method, wherein the gas atmosphere comprises one or more of nitrogen and oxygen, wherein the gas atmosphere preferably comprises air.

A further preferred embodiment (55) concretizing any one of embodiments (25) to (54) relates to said method, wherein the method further comprises

(f) subjecting the crystalline material obtained in (b), (c), (d), or (e) to an ion-exchange procedure, wherein one or more cationic non-framework elements or compounds contained in the crystalline material is ion-exchanged against one or more metal cations.

A further preferred embodiment (56) concretizing embodiment (55) relates to said method, wherein the one or more metal cations are selected from the group consisting of one or more alkali metal cations, one or more alkaline earth metal cations, and one or more transition metal cations, including mixtures of two or more thereof, wherein preferably the one or more metal cations comprise one or more transition metal cations as non-framework elements, including mixtures of two or more thereof.

A further preferred embodiment (57) concretizing embodiment (55) or (56) relates to said method, wherein the one or more transition metal cations are selected from the group consisting of cations of Zr, Cr, Mo, Fe, Co, Ni, Cu, Zn, Ru, Rh, Pd, Ag, Os, Ir, Pt, Au, and mixtures of two or more thereof.

A further preferred embodiment (58) concretizing any one of embodiments (55) to (57) relates to said method, wherein the one or more alkali metal cations are selected from the group consisting of cations of Li, Na, K, Rb, Cs, and mixtures of two or more thereof, wherein preferably the one or more alkali metal cations comprise cations of Na and/or K.

A further preferred embodiment (59) concretizing any one of embodiments (55) to (58) relates to said method, wherein the one or more alkaline earth metal cations are selected from the group consisting of cations of Mg, Ba, Sr, and mixtures of two or more thereof, wherein preferably the one or more alkaline earth metal cations comprise cations of Mg and/or Sr.

A further preferred embodiment (60) concretizing any one of embodiments (25) to (59) relates to said method, wherein the method further comprises

(g) subjecting the crystalline material obtained in (b), (c), (d), (e), or (f) to an ion-exchange procedure, wherein one or more cationic non-framework elements or compounds contained in the crystalline material is ion-exchanged against ammonium cations.

An embodiment (61) of the present invention relates to a crystalline material obtainable or obtained according to the process of any one of embodiments (25) to (60).

An embodiment (62) of the present invention relates to a use of a crystalline material according to any one of embodiments (1) to (24) or (61) as a molecular sieve, for ion-exchange, as an adsorbent, as an absorbent, as a catalyst or as a catalyst component, preferably as a catalyst or as a catalyst component, more preferably as a Lewis acid catalyst or a Lewis acid catalyst component, as a catalyst for the selective catalytic reduction (SCR) of nitrogen oxides NOₓ, for the oxidation of NH₃, in particular for the oxidation of NH₃ slip in diesel systems, for the decomposition of N₂O, as an additive in fluid catalytic cracking (FCC) processes, as an isomerization catalyst or as an isomerization catalyst component, as an oxidation catalyst or as an oxidation catalyst component, as a hydrocracking catalyst, as an alkylation catalyst, as an aldol condensation catalyst or as an aldol condensation catalyst component, as an amination catalyst, in particular for the amination of one or more of an alcohol, an epoxide, an olefin, and an aromatic, as an acylation catalyst, as an esterification catalyst, as a transesterification catalyst, or as a Prins reaction catalyst or as a Prins reaction catalyst component, more preferably as an oxidation catalyst or as an oxidation catalyst component, more preferably as an epoxidation catalyst or as an epoxidation catalyst component, more preferably as an epoxidation catalyst, or as a catalyst in the conversion of alcohols to olefins, and more preferably in the conversion of oxygenates to olefins.

### EXPERIMENTAL SECTION

The present invention is further illustrated by the following examples and reference examples.

### Reference Example 1: Determination of the Unit Cell Parameters Via Automated Electron Diffraction Tomography (ADT)

A powdered sample of the zeolitic material obtained from Example 2 was dispersed in ethanol using an ultrasonic bath and sprayed onto a carbon-coated copper grid using a sonifier for transmission electron microscopy (TEM) and automated electron diffraction tomography (ADT) investigations. The sonifier used is described in E. Mugnaioli et al., Ultramicroscopy, 109 (2009) 758-765. TEM, EDX and ADT measurements were carried out with an FEI TECNAJ F30 S-TWIN transmission electron microscope equipped with a field emission gun and working at 300 kV. TEM images and nano electron diffraction (NED) patterns were taken with a CCD camera (16-bit 4,096×4,096 pixel GATAN ULTRASCAN4000) and acquired by Gatan Digital Micrograph software. Scanning transmission electron microscopy (STEM) images were collected by a FISCHIONE high-angular annular dark field (HAADF) detector and acquired by Emispec ES Vision software. Three-dimensional electron diffraction data were collected using an automated acquisition module developed for FEI microscopes according to the procedure described in U. Kolb et al., Ultramicroscopy, 107 (2007) 507-513. For high tilt experiments, all acquisitions were performed with a FISCHIONE tomography holder. A condenser aperture of 10 μm and mild illumination settings (gun lens 8, spot size 8) were used in order to produce a semi-parallel beam of 200 nm in diameter on the sample (21 e⁻/nm²s). Crystal position tracking was performed in microprobe STEM mode and NED patterns were acquired sequentially in steps of 1°. Tilt series were collected within a total tilt range up to 120°, occasionally limited by overlapping of surrounding crystals or grid edges. ADT data were collected with electron beam precession (precession electron diffraction, PED) according to the procedure described in R. Vincent et al., UItramicroscopy, 53 (1994) 271-282. PED was used in order to improve reflection intensity integration quality as described in E. Mugnaioli et al., Ultramicroscopy, 109 (2009) 758-765. PED was performed using a Digistar unit developed by NanoMEGAS SPRL. The precession angle was kept at 1.0°. The eADT software package was used for three-dimensional electron diffraction data processing as described in U. Kolb et al., Cryst Res. Technol., 46 (2011) 542-554. Ab initio structure solution was performed assuming the kinematic approximation I≈|Fₕₖₗ|² by direct methods implemented in the program SIR2014 as described in M. C. Burla et al., Journal of Applied Crystallography, 48 (2015) 306-309. Difference Fourier mapping and least-squares refinement were performed with the software SHELXL as described in G. M. Sheldrick (2015) “Crystal structure refinement with SHELXL”, Acta Cryst., C71, 3-8 (Open Access). Scattering factors for electrons were taken from Doyle and Turner as described in P.A. Doyle et al., Acta Crystallographica Section A, 24 (1968) 390-397.

An ADT datasets were collected from isolated lying particles and reconstructed in three-dimensional diffraction volumes. For each measured particle, the diffraction volumes showed the same primitive lattice. For instance, the diffraction volume shown in FIG. 1, delivered a primitive C-centred lattice with the cell parameters a=17.4 Å, b=17.4 Å, c=14.4 Å, α=90°, β=113° and γ=90° taking a scale factor based on the effective camera length of d_{corr}/d=1.115 into account Apart from the clear extinctions according to C-centring no additional extinction rules could be found. The lattice determined by ADT refined against X-ray powder diffraction data delivered a=17.366(4) A, b=17.370(4) A, c=14.303(2) A, α=90°, β=113.76(1)°, γ=90° using space group C2. The structure was solved by direct method approach in SIR2014 with a coverage of 79% of the possible independent reflections (details listed in table 1 below). Ab initio structure solution converged to a final residual R_{F} of 0.226. The network with 66 Si and 128 O was found directly, as shown in FIG. 2 (left hand side). The potential of the missing O can be clearly seen and is indicated with a green circle. The strongest maxima of the electron density map (from 2.16 to 0.62 eÅ⁻³) correspond to 19 silicon and 33 oxygen positions and two additional positions (0.79 and 0.65 eÅ⁻³) showing high Biso, which have been not taken into account. The following 8 weakest maxima (from 0.61 to 0.36 eÅ⁻³) were also not taken into account The derived crystal structure was refined with isotropic Debye-Waller factors and stayed stable with no constraints. In order to optimize the network geometry the Si—O distances were finally constraint to 1.60(1) Å.

TABLE 1
Crystallographic information about ADT measurements
and structure solution of COE-11 with SIR2014
and structure refinement using SHELXL.

| System | COE-11 |
|---|---|
| Space group | C2 |
| a/Å | 17.45 |
| b/Å | 17.36 |
| c/Å | 14.34 |
| α/° | 90.0 |
| β/° | 113.85 |
| Y/° | 90.0 |
| V/Å³ | 3970.8 |
| Structure solution (@res 1.0 Å) | |
| Tilt range/° | −60/+50 |
| No. of sampled reflections | 18801 |
| No. of independent reflections | 1713 |
| Resolution/Å | 1.0 |
| Indep. refl. coverage/% | 79 |
| R_{sym} | 0.13 |
| Overall U/Å² | 3.64 |
| Residual R(F) (SIA2014) | 0.226 |
| Reflections/parameter ratio | 5.25 |
| No. of indep. positions | 19/33 |
| Structure refinement (@res 0.8 Å) | |
| R1 (SHELXL) for F > 4σ/all | 0.379/0.402 |
| Used reflections | 3974/4022 |
| Parameters/constraints | 199/77 |
| Residual potential/eÅ⁻³ | 0.22 |

### Reference Example 2: Determination of the BET Specific Surface Area

The BET specific surface area was determined via nitrogen physisorption at 77 K according to the method disclosed in DIN 66131.

### Reference Example 3: Determination of the Micropore Volume

The micropore volume was determined according to ISO 15901-1:2016.

### Example 1: Preparation of a COE-11 Zeolite

In a Teflon beaker having a total volume of about 45 ml, 8.75 ml of tetraethylammonium hydroxide (40 weight-% in water) were mixed with 5.35 ml of de-ionized water. 1.42 g of sodium hydroxide (NaOH; pellets) were added and dissolved. Then, 15 g of colloidal silica (30 weight-% in water; Ludox HS-30) were added under stirring. Finally, 0.5 g boric acid were added under stirring. The resulting reaction mixture had a molar ratio of H2O:SiO2 of approximately 16:1.

Thus, the Teflon beaker was filled to about ⅔ with the reaction mixture. The Teflon beaker was then equipped with a Teflon lid and put in a steel autoclave as reaction vessel. The reaction took place in an oven under static conditions (see table 2 below). The autoclave was transferred after a specific period of time from a first oven having temperature T1 to a second oven having temperature T2 within seconds and remained there for another specific period of time.

For work-up, the autoclaves were taken from the oven and cooled to room temperature within about 1 hour in water having a temperature of approximately 15° C. The solid remainder in the Teflon beaker was separated and subsequently washed with de-ionized water. Then, the solid product was dried in air at room temperature overnight.

Calcination of the solid product was done in an oven in air under static conditions. To this effect, the oven was heated from room temperature to 600° C. with a heating ramp of 1 K/min. The final temperature was hold for 10 h.

### Example 2, 3, and 4: Preparation of a COE-11 Zeolite

Examples 2, 3, and 4 were prepared similarly with the exception that different conditions for effecting crystallization were applied (see table 2 below).

In a Teflon beaker having a total volume of about 45 ml, 5.00 ml of tetraethylammonium hydroxide (35 weight-% in water) were mixed with 2.05 ml of de-ionized water. 0.71 g NaOH pellets are added and dissolved. 7.5 g of colloidal silica (30 weight-% in water; Ludox HS-30) are added under stirring. Finally, 0.25 g boric acid are added under stirring.

Thus, the Teflon beaker was filled to about ⅓ with the reaction mixture. The Teflon beaker was then equipped with a Teflon lid and put in a steel autoclave as reaction vessel. The reaction took place in an oven under static conditions (see table 2 below). The autoclave was transferred after a specific period of time from a first oven having temperature T1 to a second oven having temperature T2 within seconds and remained there for another specific period of time.

For work-up, the autoclaves were taken from the oven and cooled to room temperature within about 1 hour in water having a temperature of approximately 15° C. The solid remainder in the Teflon beaker was separated and subsequently washed with de-ionized water. Then, the solid product was dried in air at room temperature overnight

Calcination of the solid product was done in an oven in air under static conditions. To this effect, the oven was heated from room temperature to 600° C. with a heating ramp of 1 K/min. The final temperature was hold for 10 h.

Alternatively, calcination of the solid product can be done in an oven by heating from room temperature to 490° C. with a heating ramp of 2 K/min and then holding said temperature for 5 h. A thus obtained sample was found to have a BET specific surface area of 416 m²/g and a micropore volume of 0.18 cm³/g.

### Example 5: Characterization of the Products Obtained in Examples 1-4

The crystalline products obtained according to examples 1 to 4 were respectively analyzed by automated diffraction tomography (ADT) and by powder X-ray diffraction and revealed to be a zeolite of a new framework structure type which was designated as COE-11. Zeolite beta was identified as a side-product in the product mixture.

Typically, the resulting zeolitic materials obtained from the examples were respectively characterized by x-ray diffraction spectroscopy. Thus, the unit cell parameters of the product of Example 2 were determined as being: a0=17.38 Å, b0=17.36 Å, c0=14.30 Å, β=113.7°. Further, a space group symmetry C2 was found. Said unit cell dimensions are identical to those of Beta Polymorph B, indicating a structural similarity to zeolite Beta.

The chemical composition for the zeolitic material of Example 2 was found as being approximately [N(C₂H₅)₄]₄[B₄Si₂O₁₃₂], including a chemical composition of the framework of approximately [B₄Si₂O₁₃₂],wherein the framework density comprising B was found as being 16.7 T/1000 Å³. In comparison thereto, the chemical composition of the framework of zeolite beta polymorph B is [Te₆₄O₁₂₈], wherein the framework density comprising B is 16.2 T/1000 Å³.

The results of the analysis of the products of Examples 1 to 4 is displayed in Table 2 below.

TABLE 2
The composition of the reaction mixtures, the reaction parameters,
and the analysis of the respective product of Examples 1 to 4.

| | | | | | | | Analysis |
|---|---|---|---|---|---|---|---|
| | | | | | T1/° | T2/° | (approx. |
| Example | SiO₂ | SDA | NaOH | H₃BO₃ | C. | C. | composition) |
| 1 | 1.00 | 0.33 | 0.5 | 0.1 | 155, | 165, | zeolite beta, |
| | | | | | 1 d | 6 d | COE-11 |
| 2 | 1.00 | 0.33 | 0.5 | 0.1 | 155, | 165, | COE-11, |
| | | | | | 4 d | 3 d | zeolite beta |
| 3 | 1.00 | 0.33 | 0.5 | 0.1 | 155, | 165, | zeolite beta, |
| | | | | | 4 d | 3 d | COE-11 |
| 4 | 1.00 | 0.33 | 0.5 | 0.1 | 155, | 160, | zeolite beta, |
| | | | | | 1 d | 6 d | COE-11 |

Accordingly, it has surprisingly been found that the invention provides a new zeolitic material designated as COE-11, wherein said new material displays a new framework type structure.

### DESCRIPTION OF FIGURES

FIG. 1: shows the reconstructed reciprocal volume of COE-11 with monoclinic C-centered lattice. View down a, b, c is shown from top left to top right, respectively. View down c shows extinction rule hkl:h+k=2π, cut of zone [100], zone [010], zone [001] is shown from bottom left to bottom right). Extinctions 0kl:k=2n and h0l:h=2n belong to C-centering.

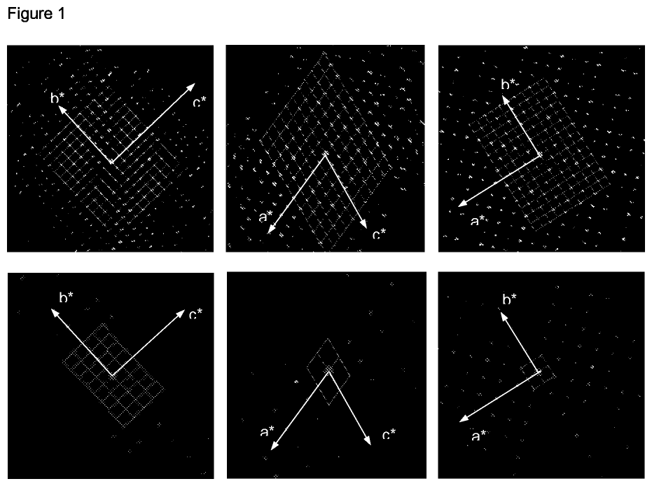

FIG. 2: illustrates the crystal structure of COE-11 drawn with the atomic potential after structure solution. The potential of the missing oxygen is indicated with a black ring (left hand side; σ=2.0); residual potential at σ=4.5 (right hand side).

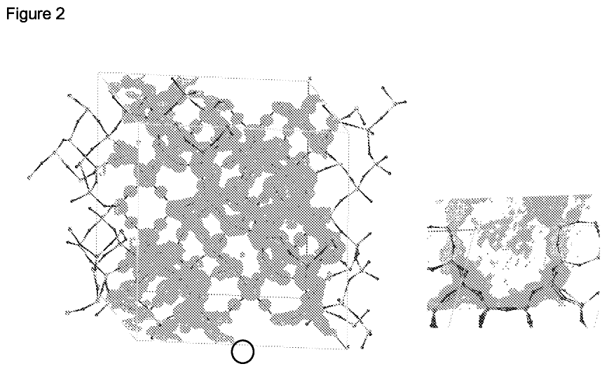

### CITED LITERATURE

Atlas of Zeolite Framework Types, 6^{th} revised edition 2007, ISBN: 978-0-444-53064-6
Verified Syntheses of Zeolitic Materials, 2^{nd} revised edition 2001, ISBN: 0-444-50703-5

1. A crystalline material having a framework structure comprising O and one or more tetravalent elements Y, and optionally comprising one or more trivalent elements X, wherein the crystalline material displays a crystallographic unit cell of the monoclinic space group C2, wherein the unit cell parameter a is in the range of from 14.5 to 20.5 Å, the unit cell parameter b is in the range of from 14.5 to 20.5 Å, the unit cell parameter c in the range of from 11.5 to 17.5 Å, and the unit cell parameter β is in the range of from 109 to 118°, wherein the framework density is in the range of from 11 to 23 T-atoms/1000 Å³, wherein the framework structure comprises 12 membered rings, and wherein the framework structure displays a 2-dimensional channel dimensionality of 12 membered ring channels.

2. The crystalline material of claim 1, wherein the crystalline material displays an X-ray diffraction pattern comprising at least the following reflections:

| Intensity (%) | Diffraction angle 2θ/° [Cu K(alpha 1)] |
|---|---|
| [68-88] | [6.65-6.85] |
| 100 | [7.43-7.63] |
| [50-70] | [8.39-8.59] |
| [6-26] | [18.21-18.41] |
| [11-31] | [21.35-21.55] |
| [78-99] | [22.64-22.84] |
| [23-43] | [25.55-25.75] |
| [1-17] | [29.80-30.00] |
| [1-20] | [44.12-44.32] |

wherein 100% relates to the intensity of the maximum peak in the X-ray powder diffraction pattern.

3. The crystalline material of claim 1, wherein the T-atoms in the framework structure of the crystalline material are located at the following sites of the unit cell:

| T-atom | Site | | | |
|---|---|---|---|---|
| name | Multiplicity | x | y | z |
| T₁ | 2 | 1.0000 | 0.8801 | 0.5000 |
| T₂ | 4 | 0.6904 | 0.1943 | 0.4939 |
| T₃ | 2 | 0.5000 | 0.9983 | 0.5000 |
| T₄ | 4 | 0.8179 | 0.0629 | 0.5032 |
| T₅ | 4 | 0.5199 | 0.1144 | 0.3516 |
| T₆ | 4 | 0.6287 | 0.8721 | 0.5053 |
| T₇ | 4 | 0.7942 | 0.8164 | 0.6628 |
| T₈ | 4 | 0.6071 | 0.0523 | 0.2160 |
| T₉ | 2 | 1.0000 | 0.2405 | 0.5000 |
| T₁₀ | 4 | 0.7071 | 0.9256 | 0.3638 |
| T₁₁ | 4 | 0.8306 | 0.8013 | 0.3560 |
| T₁₂ | 4 | 0.7361 | 0.1810 | 0.2119 |
| T₁₃ | 4 | 0.9012 | 0.1203 | 0.3477 |
| T₁₄ | 4 | 1.0987 | 0.7417 | 0.7765 |
| T₁₅ | 4 | 0.9714 | 0.8700 | 0.7841 |
| T₁₆ | 4 | 0.9760 | 0.9994 | 0.6561 |
| T₁₇ | 4 | 0.6278 | 0.2027 | −0.0074 |
| T₁₈ | 2 | 0.5000 | 0.0771 | 0.0000 |
| T₁₉ | 2 | 0.5000 | 0.3323 | 0.0000 |

wherein x, y, and z refer to the axes of the unit cell.

4. The crystalline material of claim 1, wherein the coordination sequences and the vertex symbols of the T-atoms in the framework structure of the crystalline material are as follows:

| T-atom | | | | | | | | | | | | | |
|---|---|---|---|---|---|---|---|---|---|---|---|---|---|
| name | N₁ | N₂ | N₃ | N₄ | N₅ | N₆ | N₇ | N₈ | N₉ | N₁₀ | N₁₁ | N₁₂ | Vertex Symbol |
| T₁ | 1 | 4 | 12 | 19 | 35 | 45 | 75 | 116 | 146 | 166 | 200 | 249 | 5.5.5.5.5₂.6₂ |
| T₂ | 1 | 4 | 12 | 21 | 32 | 50 | 79 | 107 | 142 | 173 | 212 | 255 | 5.5.5.6₂.5₂.12 |
| T₃ | 1 | 4 | 11 | 24 | 37 | 49 | 71 | 110 | 154 | 178 | 199 | 258 | 4.6₂.5.5.12₂.12₂ |
| T₄ | 1 | 4 | 12 | 20 | 33 | 50 | 73 | 108 | 143 | 175 | 210 | 249 | 5.5.5.5₂.5.12 |
| T₅ | 1 | 4 | 12 | 19 | 34 | 52 | 76 | 109 | 141 | 171 | 212 | 258 | 5.5.5.6.5₂.6 |
| T₆ | 1 | 4 | 11 | 23 | 35 | 52 | 72 | 106 | 147 | 180 | 211 | 249 | 4.5.5.5.12.12₂ |
| T₇ | 1 | 4 | 12 | 18 | 33 | 53 | 79 | 109 | 134 | 171 | 217 | 259 | 5.5.5.5.5₂.6 |
| T₈ | 1 | 4 | 11 | 19 | 32 | 55 | 78 | 106 | 131 | 175 | 217 | 268 | 4.5₂.5.5.5.12₃ |
| T₉ | 1 | 4 | 11 | 21 | 36 | 52 | 74 | 102 | 140 | 182 | 221 | 247 | 4.5₂.5.5.12.12 |
| T₁₀ | 1 | 4 | 12 | 21 | 35 | 51 | 75 | 107 | 146 | 175 | 211 | 255 | 5.5.5.5₂.6.12₂ |
| T₁₁ | 1 | 4 | 12 | 24 | 32 | 50 | 77 | 112 | 147 | 175 | 204 | 263 | 5.5.5.6.6₂.12₂ |
| T₁₂ | 1 | 4 | 11 | 19 | 32 | 55 | 80 | 103 | 135 | 170 | 225 | 263 | 4.5₂.5.5.5.12₃ |
| T₁₃ | 1 | 4 | 12 | 20 | 33 | 52 | 76 | 107 | 140 | 173 | 215 | 256 | 5.5.5.5₂.5.12₂ |
| T₁₄ | 1 | 4 | 11 | 21 | 34 | 53 | 79 | 109 | 137 | 171 | 221 | 262 | 4.6₂.5.5.5.12₃ |
| T₁₅ | 1 | 4 | 11 | 21 | 34 | 53 | 81 | 107 | 139 | 173 | 213 | 270 | 4.6₂.5.5.5.12₃ |
| T₁₆ | 1 | 4 | 12 | 22 | 32 | 52 | 74 | 113 | 147 | 168 | 205 | 261 | 5.5.5.6.5₂.12₂ |
| T₁₇ | 1 | 4 | 9 | 18 | 32 | 54 | 80 | 103 | 127 | 171 | 219 | 275 | 4.4.4.12₄.5.5 |
| T₁₈ | 1 | 4 | 9 | 18 | 32 | 54 | 82 | 100 | 127 | 170 | 228 | 266 | 4.4.4.12₄.5.5 |
| T₁₉ | 1 | 4 | 9 | 18 | 32 | 54 | 78 | 106 | 127 | 170 | 222 | 258 | 4.4.4.12₄.5.5 |

wherein the Vertex Symbol refers to the size and number of the shortest ring on each angle of the T-atom, according to M. O'Keeffe and S. T. Hyde, Zeolites 19, 370 (1997).

5. The crystalline material of claim 1, wherein the Y:X molar ratio of the framework structure is in the range of from 1 to 100.

6. The crystalline material of claim 1, wherein the one or more tetravalent elements Y are selected from the group consisting of Si, Sn, Ti, Zr, Ge, and mixtures of two or more thereof.

7. The crystalline material of claim 1, wherein the optional one or more trivalent elements X are selected from the group consisting of Al, B, In, Ga, and mixtures of two or more thereof.

8. The crystalline material of claim 1, wherein the crystalline material is a zeolite.

9. A method for the production of a crystalline material the method comprising
(a) preparing a mixture comprising one or more sources of YO₂, optionally one or more sources of X₂O₃, one or more tetraalkylammonium cation R¹R²R³R⁴N⁺-containing compounds as structure directing agent, and optionally comprising seed crystals, wherein Y stands for a tetravalent element and X stands for a trivalent element;
(b) heating the mixture prepared in (a) for obtaining a crystalline material;
(c) optionally isolating the crystalline material obtained in (b);
(d) optionally washing the crystalline material obtained in (b) or (c);
(e) optionally drying and/or calcining the crystalline material obtained in (b), (c), or (d);
wherein R¹, R², R³, and R⁴ independently from one another stand for alkyl.

10. The process of claim 9, wherein a molar ratio R¹R²R³R⁴N⁺:YO₂ of the one or more tetraalkylammonium cations to the one or more sources of YO₂ calculated as YO₂ in the mixture provided according to (a) is comprised in the range of from 0.001 to 10.

11. The process of claim 9, wherein a YO₂:X₂O₃ molar ratio of the one or more sources of YO₂ calculated as YO₂ to the one or more sources of X₂O₃ calculated as X₂O₃ in the mixture prepared in (a) is in the range of from 1 to 50.

12. The process of claim 9, wherein the mixture prepared in (a) further comprises a solvent system containing one or more solvents.

13. The process of claim 9, wherein the heating in (b) is conducted under autogenous pressure.

14. A crystalline material obtainable or obtained according to the process of claim 9.

15. (canceled)
